(19) United States
(12) Patent Application Publication
(10) Pub. No.: US 2003/0104754 A1
(43) Pub. Date: Jun. 5, 2003

(54) Apparatus for assembling and inspecting electron gun of cathode ray tube

(76) Inventor: Nobuhide Hinomoto, Tokyo (JP)

Correspondence Address: BIRCH STEWART KOLASCH & BIRCH, PO BOX 747, FALLS CHURCH, VA, 22040-0747, US

(21) Appl. No.: 10/216,222

(22) Filed: Aug. 12, 2002

(30) Foreign Application Priority Data
Dec. 5, 2001 (JP) 2001-371521

(51) Int. Cl. H05B 33/10; H01J 9/46

(52) U.S. Cl. 445/66; 445/67

(57) ABSTRACT

An apparatus for assembling and inspecting an electron gun of a cathode ray tube includes a mandrel 5 and a measuring nozzle 2. The mandrel 5 has an outer diameter larger than the electron-beam-transmission hole of the Gm electrode 30. The mandrel 5 abuts against the Gm electrode 30 from G3 electrode 40 side, to seal the electron-beam-transmission hole of the Gm electrode 30. The measuring nozzle 2 has a tip that can be inserted through the electron-beam-transmission holes of the G1 and G2 electrodes from the G1 electrode side, and blows air toward the mandrel 5. A clearance between the G2 and Gm electrodes are measured according to the change in pressure of the blown air. It is possible to measure the clearance between the electrodes required for assembling the electron gun having the Gm electrode with a small electron-beam-transmission hole.

### BACKGROUND OF THE INVENTION

The present invention relates to an apparatus for assembling and inspecting an electron gun of a cathode ray tube.

As disclosed in Japanese laid-open patent publication No. HEI5-190097, a conventional apparatus for assembling and inspecting an electron gun of a cathode ray tube uses a measuring nozzle. The tip of the measuring nozzle is moved in and out of the electron-beam-transmission holes formed in the G1 and G2 electrodes of the electron gun assembly, thereby to measure the clearance between the electrodes. Thus, the inspecting method disclosed in the above-mentioned publication can be carried out only when the outer diameter of the measuring nozzle is smaller than the inner diameters of the electron-beam-transmission holes of the electrodes.

In an example disclosed in the above-mentioned publication, the inner diameters D_{G1}, D_{G2} and D_{G3} of the respective electron-beam-transmission holes of the G1, G2 and G3 electrodes satisfy the following relationship: D_{G1}(0.3 mm)≦D_{G2}≦D_{G3}.

However, there are types of electron gun of the cathode ray tube that have recently come into use, employing improved structures for improving the focus characteristics. One type of electron gun has a structure in which the inner diameter of the electron-beam-transmission hole of the G2 electrode is smaller than that of the electron-beam-transmission hole of the G1 electrode. Another type of electron gun has an additional electrode (hereinafter, referred to as a Gm electrode) provided between G2 and G3 electrodes. The electron-beam-transmission hole of the Gm electrode is smaller than those of the G2 and G3 electrodes.

Since the above-mentioned clearance between the electrodes and a clearance between the cathode and the G1 electrode have a large effect on a cut-off performance of the electron gun, it is necessary to precisely measure the clearances, during the assembling of the electron gun.

However, in order to use the method disclosed in the above-mentioned publication, the electron-beam-transmission holes of the respective electrodes must be greater than the outer diameter of the measuring nozzle. Further, each electrode must be constructed so that a portion around its electron-beam-transmission hole can be observed by means of an imaging device.

Accordingly, if the electron gun of the cathode ray tube employs the above-mentioned improved structure, it is difficult to measure the clearance between the electrodes by means of the inspecting apparatus disclosed in the above-mentioned publication.

This problem is described further referring to FIG. 8 and FIG. 9. In FIG. 8, the reference numeral 108 denotes the measuring nozzle having the outer diameter Dₚ and the inner diameter Dᵣ. The reference numeral 120 denotes the G2 electrode. The reference numeral 130 denotes the Gm electrode having an electron-beam-transmission hole of the inner diameter D_{q}.

The inner diameter Dᵣ of the measuring nozzle 108 is preferably larger than or equal to 0.15 mm (Dᵣ≧0.15 mm), because of a requirement for machining and a requirement for precisely measuring the distance toward the object according to the change in pressure of the air flowing through the measuring nozzle 108. Further, in order to obtain a sufficient rigidity of the measuring nozzle 108, it is necessary that the thickness of the wall of the measuring nozzle 108 is greater than or equal to 0.04 mm. Accordingly, it is necessary that the outer diameter of the measuring nozzle 108 is greater than or equal to 0.23 mm (Dₚ≧0.23 mm).

Thus, in order to use the measuring nozzle 108, the inner diameter D_{q} of the electron-beam-transmission hole of the Gm electrode 130 should be greater than 0.23 mm (D_{q}>0.23 mm).

However, in order to improve the focus characteristics (that is, for better concentration of the electron beam on a small spot on the screen) for projecting sharp characters or images on the screen, and in order to improve the drive characteristics (that is, to increase the amount of emission current relative to the cathode voltage) for projecting a bright image on the screen, it is necessary that the inner diameter D_{q} of the electron-beam-transmission hole of the Gm electrode is smaller than or equal to 0.2 mm (D_{q}≦0.2 mm). Thus, the inner diameter D_{q} of the electron-beam-transmission hole of the Gm electrode that is required for the desired performance is smaller than the outer diameter of the measuring nozzle 108. Thus, due to the limitation of the outer diameter of the measuring nozzle 108, the conventional inspecting apparatus can not be used to measure the clearance required for calculating the mounting position of the cathode.

Further, as shown in FIG. 9, there is still another type of electron gun in which the G2 electrode 120 and the G3 electrode 130 have a drawn part and an extruded part respectively formed around the electron-beam-transmission holes. Those drawn and extruded parts are provided for decreasing the thicknesses of the parts around the electron-beam-transmission holes of the G2 and G3 electrodes. With such a structure, only a width denoted by “h” in FIG. 9 can be measured by means of a light source 103 and an imaging device 104 provided for measuring the clearance between the G2 electrode 120 and the Gm electrode 130. Accordingly, in order to precisely calculate the actual clearance between the G2 electrode 120 and the Gm electrode 130, it is necessary to maintain the exact tolerance on the height (that is, the dimension in a direction of the insertion of the measuring nozzle) of each part of the electrodes, and to subtract the heights of the respective parts from the measured width “h”. However, it is difficult to maintain such exact tolerance on the heights of the parts of the electrodes, since the electrodes are mass-manufactured.

### SUMMARY OF THE INVENTION

This invention is intended to solve the above described problems, and an object of the present invention is to provide an apparatus for assembling and inspecting an electron gun of a cathode ray tube, capable of precisely measuring the clearance between electrodes to determine a cathode mounting position, for assembling the electron gun having excellent drive characteristics and focus characteristics.

According to the invention, there is provided an apparatus for assembling and inspecting an electron gun of a cathode ray tube. The electron gun includes a cathode, a G1 electrode that derives electrons from the cathode, a G2 electrode, a G3 electrode that accelerates emitted electrons toward a screen as a display surface. The G1 through G3 electrodes respectively have electron-beam-transmission holes. A Gm electrode is provided between the G2 and G3 electrodes. The Gm electrode has an electron-beam-transmission hole smaller than the electron-beam-transmission holes of the G1 through G3 electrodes. Inner diameters D1, D2 and Dm of the electron-beam-transmission holes of the G1, G2 and Gm electrodes satisfy the relationship: D1≧D2>Dm. The apparatus includes a mandrel having an outer diameter larger than the inner diameter of the electron-beam-transmission hole of the Gm electrode. The mandrel abuts against a part around the electron-beam-transmission hole of the Gm electrode from the G3 electrode side, thereby to seal the electron-beam-transmission hole of the Gm electrode. The apparatus further includes a measuring nozzle having a tip that can be inserted into the electron-beam-transmission holes of the G1 and G2 electrodes from the G1 electrode side. The measuring nozzle blows air toward the mandrel, for measuring a clearance between the G2 and Gm electrodes according to the change in pressure of blown air.

According to another aspect of the invention, there is provided an apparatus for assembling and inspecting an electron gun of a cathode ray tube. The apparatus includes a cylindrical electrode that can be inserted through the electron-beam-transmission holes of the G1 and G2 electrodes from the G1 electrode side. The apparatus further includes an ohmmeter one end of which is connected to the cylindrical electrode, and the other end of which is connected to the Gm electrode. A clearance between the G2 and Gm electrodes is measured by detecting the contact position of the cylindrical electrode and the Gm electrode according to a resistance measured by the ohmmeter.

It is possible to precisely measure the clearance of the electrodes required for assembling the electron gun that has the Gm electrode with a small electron-beam-transmission hole provided between the G2 and G3 electrodes. Thus, it is possible to precisely assemble the electron gun provided with the Gm electrode having a small electron-beam-transmission hole, that is, the electron gun having a large emission current relative to the cathode voltage and having excellent focus characteristics.

### BRIEF DESCRIPTION OF THE DRAWINGS

In the attached drawings:

FIG. 1 is a sectional view illustrating an electron gun used in Embodiment 1 of the present invention;

FIG. 2 is a sectional view illustrating an apparatus for assembling and inspecting the electron gun according to Embodiment 1;

FIG. 3 is a sectional view illustrating a measuring method according to Embodiment 1;

FIG. 4 is a sectional view illustrating the measuring method according to Embodiment 1;

FIG. 5 is a sectional view illustrating an apparatus for assembling and inspecting the electron gun according to Embodiment 2;

FIG. 6 is a sectional view illustrating an apparatus for assembling and inspecting the electron gun according to Embodiment 3;

FIG. 7 is a sectional view illustrating an apparatus for assembling and inspecting the electron gun according to Embodiment 4;

FIG. 8 is a sectional view illustrating an example of an electron gun having a Gm electrode;

FIG. 9 is a sectional view illustrating a conventional method for measuring the clearance between electrodes.

### DETAILED DESCRIPTION OF THE INVENTION

Embodiments of the invention will be described with reference to the attached drawing.

Embodiment 1.

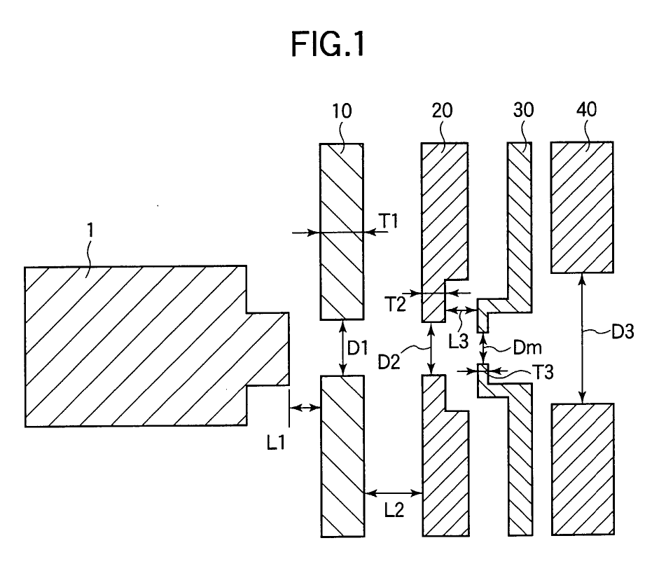

FIG. 1 shows an example of an electron gun of a cathode ray tube according to Embodiment 1. The reference numeral 1 denotes a cathode. The reference numeral 10 denotes a G1 electrode which derives electrons from the cathode 1. The reference numeral 20 denotes a G2 electrode. The reference numeral 30 denotes a Gm electrode. The reference numeral 40 denotes a G3 electrode that accelerates electrons emitted from the cathode 1 toward a screen as a display surface. The G1 electrode 10, the G2 electrode 20, the Gm electrode 30 and the G3 electrode 40 respectively have electron-beam-transmission holes. Inner diameters D1, D2, Dm, D3 of the respective electron-beam-transmission holes of the G1, G2, Gm, G3 electrode 10, 20, 30, 40 satisfy the following relationship: D3>D1≧D2>Dm.

The examples of dimensions of the respective electrodes shown in FIG. 1 are as follows: D1=0.4 mm, D2=0.4 mm, Dm=0.14 mm, D3=1.3 mm, T1=0.08 mm, T2=0.1 mm, T3=0.15 mm, L1=0.1 mm, L2=0.12 mm, and L3=0.1 mm.

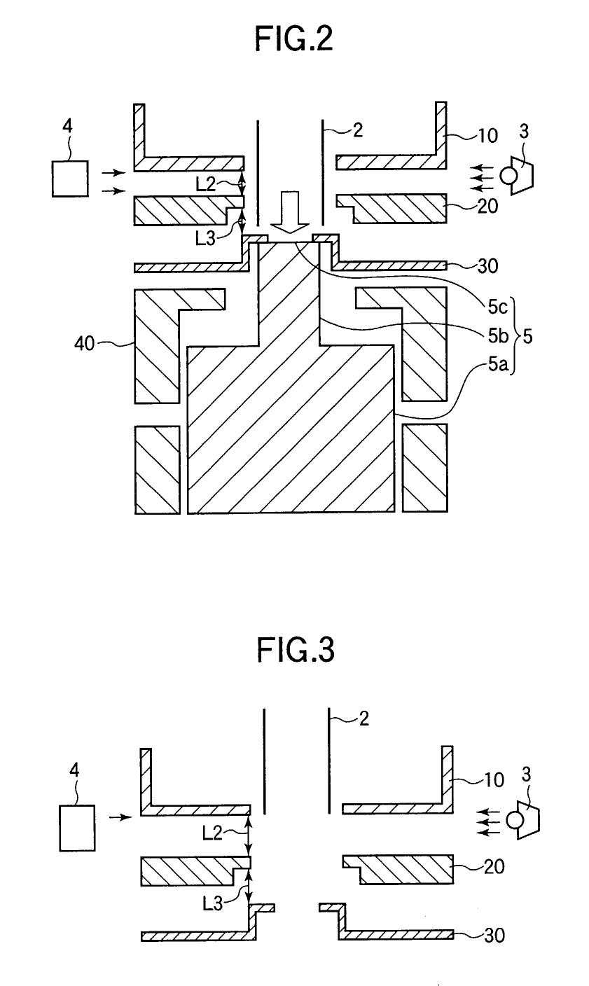

In Embodiment 1, the clearance L2 between the G1 electrode 10 and the G2 electrode 20 and the clearance L3 between the G2 electrode 20 and the Gm electrode 30 are measured according to the following process. In FIG. 2, the reference numeral 2 denotes a measuring nozzle of an air micrometer. The reference numeral 3 denotes a light source. The reference numeral 4 denotes an imaging device. The reference numeral 5 denotes a mandrel. The mandrel 5 includes a first cylindrical portion 5a and a second cylindrical portion 5b having a smaller diameter than the first cylindrical portion 5a. The second cylindrical portion 5b is coaxial with and protruding from the first cylindrical portion 5a. The second cylindrical portion 5b has an outer diameter larger than the electron-beam-transmission hole of the Gm electrode 30. For measurement, the electron gun of the cathode ray tube (that is, an object of measurement) is mounted on the mandrel 5, so that a tip 5c of the second cylindrical portion 5b of the mandrel 5 abuts against a part around the electron-beam-transmission hole of the Gm electrode 30, thereby to support the electron gun thereon, and to seal the electron-beam-transmission hole of the Gm electrode 30. The respective electrodes of the electron gun are fixed to and held by a support member (not shown) made of bead glass.

<Measuring Process of the Clearance L2 between the G1 and G2 Electrodes>

FIG. 3 shows a measuring process of the clearance L2 between the G1 electrode 10 and the G2 electrodes 20.

First, the measuring nozzle 2 is inserted through electron-beam-transmission hole of the G1 electrode 10, and is moved toward the Gm electrode 30. The air micrometer having this measuring nozzle 2 is provided with a micro gauge (not shown), which measures the distance traveled by the measuring nozzle 2. The micro gauge is used in combination with a light source 3 and the imaging device 4. The imaging device 4 is used to observe a silhouette of tip of the measuring nozzle 2.

When the measuring nozzle 2 inserted through the G1 electrode 10 is slightly projected from the lower surface or end of the G1 electrode 10, the micro gauge is set to 0 mm. Then, when the measuring nozzle 2 passes through the G2 electrode 20, the indication value of the micro gauge is read. The clearance L2 is measured according to this reading of the micro gauge. In this connection, “when the measuring nozzle 2 passes through a certain electrode” is determined by detecting when the silhouette of the tip of the measuring nozzle 2 contacts the silhouette of the certain electrode.

<Measuring Process of the Clearance L3 between the G2 and Gm Electrodes>

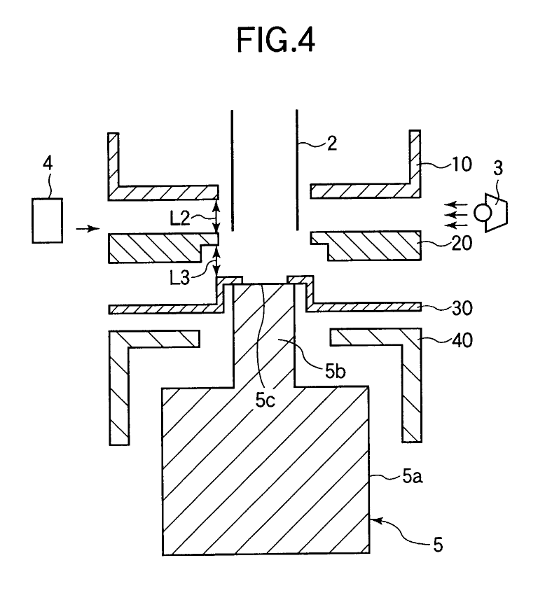

FIG. 4 shows a measuring process of the clearance L3 between the G2 electrode 20 and the Gm electrode 30. In this process, the tip 5c of the mandrel 5 is pressed against the Gm electrode 30 from the G3 electrode 40 side, so that the electron-beam-transmission hole of the Gm electrode 30 is sealed by the tip 5c of the mandrel 5. The measuring nozzle 2 is advanced toward the Gm electrode 30 from the G1 electrode 10 side, while blowing air toward the mandrel 5. The clearance L3 between the G2 electrode 20 and the Gm electrode 30 is measured according to the change in the pressure of the air blown by the measuring nozzle 2.

Specifically, when the measuring nozzle 2 passes through the G1 electrode side of the G2 electrode 20, the micro gauge is set to 0 mm. Then, the measuring nozzle 2 is slowly advanced toward the Gm electrode 30, while blowing air toward the mandrel 5. When the pressure of the air blown by the measuring nozzle 2 reaches the predetermined value, the micro gauge is read. The clearance L3 is obtained by subtracting the thicknesses of the G2 electrode 20 (the thickness of the part of the G2 electrode 20 which surrounds the electron-beam-transmission hole) and the Gm electrode 30 from the above-mentioned reading of the micro gauge. The relationship between the air pressure and the distance to the object is obtained, prior to the measurement.

<Calculating Process of the Cathode Mounting Position>

After the clearance L2 between the G1 electrode 10 and the G2 electrode 20 and the clearance L3 between the G2 electrode and the Gm electrode 30 are measured as described above, the measuring nozzle 2 is removed. Then, the mounting position of the cathode 1 is calculated based on the measured clearances L2 and L3, so as to obtain a designed cut-off voltage. In this process, the position for mounting the cathode can be individually determined for each cathode, based on measured clearances L1 and L2. Thus, it is possible to maintain uniform cut-off voltage.

<Welding Process of the Cathode>

The cathode 1 is inserted to its mounting position in the same direction as the insertion of the measuring nozzle 2. Then, the cathode 1 is welded by means of laser to a cathode support (not shown), so that the cathode 1 is fixed to the mounting position calculated in the previous process. Thus, the mounting position of the cathode can be individually adjusted for each cathode. That is, among a plurality of cathodes, cut-off voltage can coincide with each other. Therefore, the variation in performance of the cathode ray tubes can be reduced.

As described above, using the apparatus for assembling and inspecting the electron gun according to the embodiment 1, it is possible to precisely measure the clearance between the electrodes and to precisely mount the cathode to the predetermined position.

Embodiment 2.

Embodiment 2 relates to a method for improving the contact between the blown air and the Gm electrode 30, thereby to further improve the preciseness in the measurement.

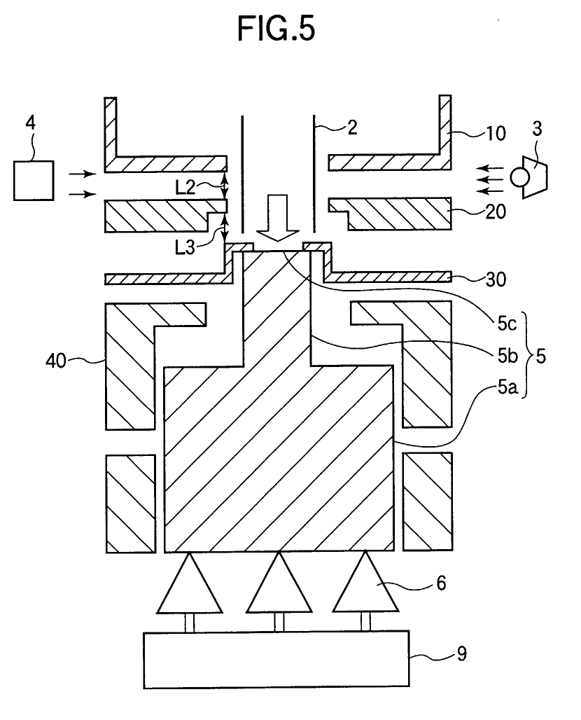

In FIG. 5, the reference numeral 6 denotes resilient members which press the mandrel 5 against the Gm electrode 30. Each resilient member 6 may comprise a compression spring having one end pressed against the bottom surface of the mandrel 5. By the combination of the mandrel 5 and the resilient member 6, the tip 5c of the mandrel 5 is resiliently pressed against the Gm electrode 30 with a pressure obtained by resilient members 6. With this, the mandrel 5 effectively seals the electron-beam -transmission hole of the Gm electrode 30. Thus, the measuring nozzle 2 is able to further precisely detect the change in the pressure of the blown air. Accordingly, it is possible to further precisely measure the clearance L3.

Further, the reference numeral 9 denotes an adjusting mechanism which adjusts the pressure with which the mandrel 5 is pressed against the Gm electrode 30. The adjusting mechanism 9 may comprise a means for adjusting the position of the other end of each of the above-mentioned compression springs toward and away from the mandrel 5, to adjust the above-mentioned pressure.

Embodiment 3.

Embodiment 3 relates to a method for detecting the extent of contact between the mandrel 5 and the Gm electrode 30.

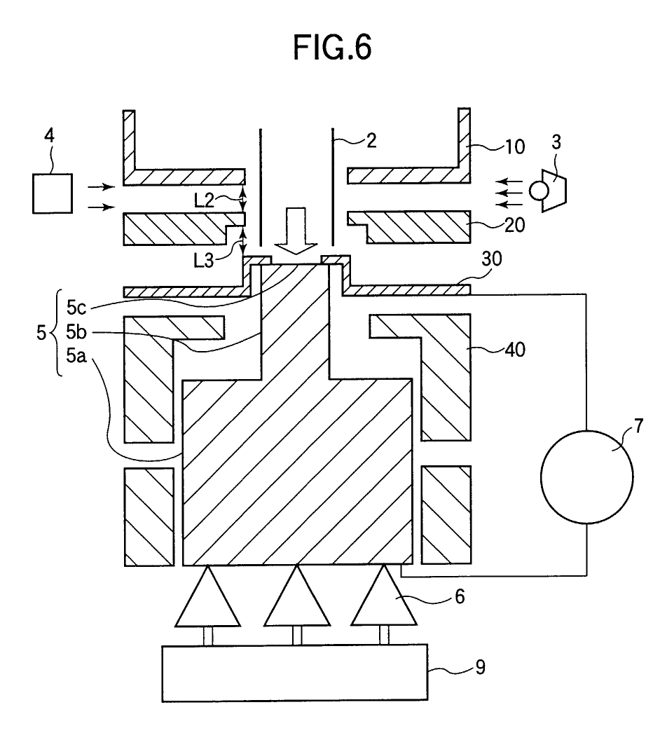

In FIG. 6, the reference numeral 7 denotes an ohmmeter electrically connected to the mandrel 5 and the Gm electrode 30. In order to detect the extent of contact between the tip 5c of the mandrel 5 and the Gm electrode 30, the resistance indication on the ohmmeter 7 is read. The resistance measured by the ohmmeter 7 represents the contact resistance between the mandrel 5 and the Gm electrode 30. If the contact resistance is low, it indicates that the mandrel 5 and the Gm electrode 30 well contact with each other. However, it may also indicate that the pressure applied to the Gm electrode 30 is stronger than necessary.

In this embodiment 3, the pressure applied to the Gm electrode 30 can be controlled according to the detected contact resistance between the mandrel 5 and the Gm electrode 30. For example, the above-mentioned adjusting mechanism 9 can be used to adjust the pressure applied to the Gm electrode 30 according to the detected contact resistance. With such an arrangement, the deformation of the Gm electrode 30 can be prevented, while the electron-beam-transmission hole of the Gm electrode 30 can be appropriately sealed. Thus, the clearance L3 can be further precisely measured.

Embodiment 4.

Embodiment 4 relates to an apparatus for assembling and inspecting the electron gun, which performs the measurement without using a measuring nozzle.

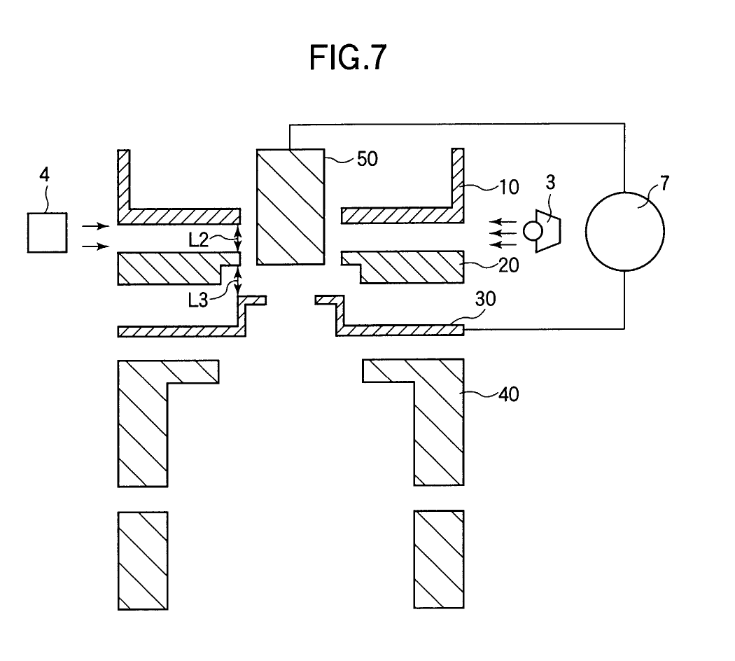

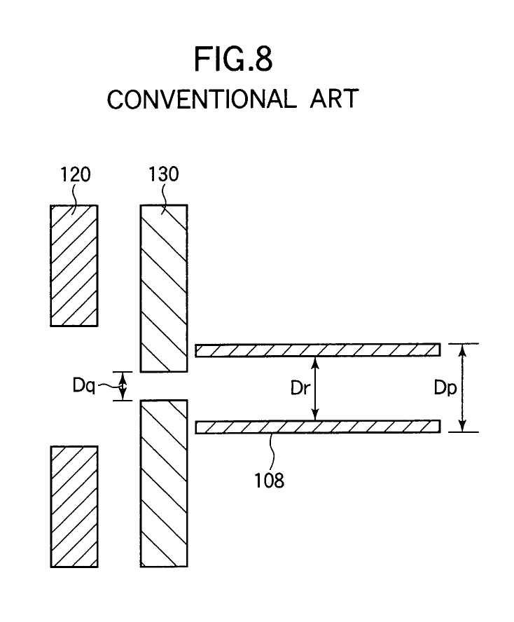

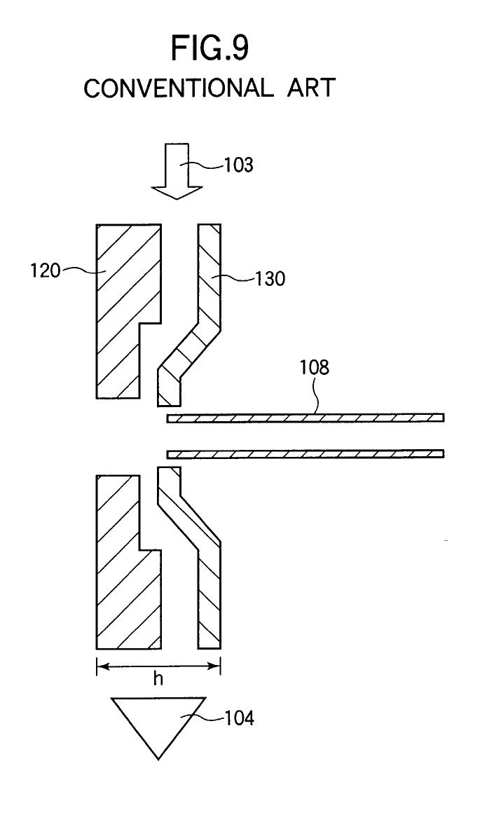

In FIG. 7, the reference numeral 50 denotes a cylindrical electrode that replaces the measuring nozzle 2 used in the previous embodiments 1 through 3. The cylindrical electrode 50 is electrically connected to the Gm electrode 30 via the ohmmeter 7. The cylindrical electrode 50 is inserted from the G1 electrode 10 side toward the Gm electrode 30. The distance traveled by the cylindrical electrode 50 is measured by a micrometer (not shown).

Specifically, when the cylindrical electrode 50 passes through the G1 electrode side of the G2 electrode 20, the micro gauge is set to 0 mm. Then, the cylindrical electrode 50 is advanced toward the Gm electrode 30. When the resistance detected by the ohmmeter 7 changes (that is, when the cylindrical electrode 50 contacts the Gm electrode 30), the micrometer is read. The clearance L3 is obtained by subtracting the thicknesses of the G2 electrode 20 and the Gm electrode 30 from the above-mentioned reading of the micrometer.

What is claimed is:

1. An apparatus for assembling and inspecting an electron gun of a cathode ray tube,
said electron gun comprising:
a cathode;
a G1 electrode that derives electrons from said cathode;
a G2 electrode;
a G3 electrode that accelerates emitted electrons toward a screen as a display surface, said G1 thorough G3 electrodes respectively having electron-beam-transmission holes; and
a Gm electrode provided between said G2 and G3 electrodes, and having an electron-beam-transmission hole that is smaller than said electron-beam-transmission holes of said G1 through G3 electrodes, inner diameters D1, D2 and Dm of said electron-beam-transmission holes of said G1, G2 and Gm electrodes satisfying the relationship: D1≧D2>Dm, said apparatus comprising:
a mandrel having an outer diameter that is larger than said inner diameter of said electron-beam-transmission hole of said Gm electrode, said mandrel abutting against a part around said electron-beam-transmission hole of said Gm electrode from said G3 electrode side, thereby to seal said electron-beam -transmission hole of said Gm electrode; and
a measuring nozzle having a tip that can be inserted through said electron-beam-transmission holes of said G1 and G2 electrodes from said G1 electrode side, said measuring nozzle blowing air toward said mandrel, for measuring a clearance between said G2 and Gm electrodes according to the change in pressure of blown air.

2. The apparatus as set forth in claim 1, further including a resilient member which resiliently presses said mandrel against said Gm electrode, thereby adjusting a contact pressure between said mandrel and said Gm electrode, said mandrel sealing said electron-beam-transmission hole of said Gm electrode.

3. The apparatus as set forth in claim 1, further including an ohmmeter connected to said Gm electrode and said mandrel which seals said electron-beam-transmission hole of said Gm electrode;
wherein an extent of contact between said mandrel and said Gm electrode is detected according to a resistance measured by said ohmmeter.

4. The apparatus as set forth in claim 1, further including an adjusting mechanism used to adjust the pressure with which said mandrel is pressed against said Gm electrode.

5. An apparatus for assembling and inspecting an electron gun of a cathode ray tube,
said electron gun comprising:
a cathode;
a G1 electrode that derives electrons from said cathode;
a G2 electrode;
a G3 electrode that accelerates emitted electrons toward a screen as a display surface, said G1 thorough G3 electrodes respectively having electron-beam-transmission holes; and
a Gm electrode provided between said G2 and G3 electrodes, and having an electron-beam-transmission hole that is smaller than said electron-beam-transmission holes of said G1 through G3 electrodes, inner diameters D1, D2 and Dm of said electron-beam-transmission holes of said G1, G2 and Gm electrodes satisfying the relationship: D1≧D2>Dm, said apparatus comprising:
a cylindrical electrode that can be inserted through said electron-beam-transmission holes of said G1 and G2 electrodes from said G1 electrode side; and
an ohmmeter one end of which is connected to said cylindrical electrode, and the other end of which is connected to said Gm electrode,
wherein a clearance between said G2 and Gm electrodes is measured by detecting the contact position of said cylindrical electrode and said Gm electrode according to a resistance measured by said ohmmeter.
